(19) United States
(12) Patent Application Publication
(10) Pub. No.: US 2018/0062210 A1
(43) Pub. Date: Mar. 1, 2018

(54) BATTERY MANAGEMENT SYSTEM

(71) Applicant: Samsung SDI Co., Ltd., Yongin-si (KR)

(72) Inventor: Duk-Jung Kim, Yongin-si (KR)

(21) Appl. No.: 15/408,067

(22) Filed: Jan. 17, 2017

(30) Foreign Application Priority Data
Aug. 30, 2016 (KR) 10-2016-0110956

(51) Int. Cl. H01M 10/42; H01M 10/48; H01M 10/0525; H02J 7/00

(52) U.S. Cl. CPC H01M 10/425; H01M 10/482; H01M 10/0525; H01M 2220/20; H02J 7/0026; H01M 2010/4271; H01M 2010/4278; H01M 10/4228

(57) ABSTRACT

An embodiment of the present invention provides a battery management system including an insulation resistance estimator configured to estimate insulation resistance corresponding to internal temperature and pressure of a battery pack to obtain an estimated value of the insulation resistance, a concentration estimator configured to estimate an internal gas concentration of the battery pack corresponding to the estimated value of the insulation resistance, a cell failure detector configured to detect whether a plurality of battery cells fail based on a state of charge (SOC) and a voltage of the plurality of battery cells accommodated in the battery pack, and a leak determiner configured to determine whether a battery cell leaks based on a detected result of the cell failure detector and based on the internal gas concentration corresponding to the estimated value of the insulation resistance.

### CROSS-REFERENCE TO RELATED APPLICATION

This application claims priority to, and the benefit of, Korean Patent Application No. 10-2016-0110956 filed in the Korean Intellectual Property Office on Aug. 30, 2016, the entire contents of which are incorporated herein by reference.

### BACKGROUND

### 1. Field

Embodiments of the present invention relate to a battery management system.

### 2. Description of the Related Art

Recently, according to strengthening of environmental regulations, including CO₂ regulations, interest in environmentally-friendly vehicles has been increasing. Accordingly, vehicle companies have been actively researching and developing pure electrical vehicles and hydrogen vehicles, as well as hybrid and plug-in hybrid vehicles.

A high voltage battery for storing electrical energy obtained from various energy sources is applied to the environmentally-friendly vehicles. The high voltage battery applied to the vehicles may include a lithium-ion battery.

Sealing of a battery cell and a battery pack of the high voltage lithium-ion battery is a major factor affecting operation/performance and high voltage safety of the vehicle. In the lithium-ion battery, inappropriate sealing of the battery cell may accelerate deterioration of the battery cell, and inappropriate sealing of the battery pack may cause an insulation breakdown, thereby causing or increasing a leakage current.

The above information is only for enhancement of understanding of the background of embodiments of the invention, and therefore may contain information that does not form the prior art.

### SUMMARY

Embodiments of the present invention provide a battery management system that may improve detection of sealing failures of a battery cell and a battery pack.

An embodiment of the present invention provides a battery management system including an insulation resistance estimator configured to estimate insulation resistance corresponding to internal temperature and pressure of a battery pack to obtain an estimated value of the insulation resistance, a concentration estimator configured to estimate an internal gas concentration of the battery pack corresponding to the estimated value of the insulation resistance, a cell failure detector configured to detect whether a plurality of battery cells fail based on a state of charge (SOC) and a voltage of the plurality of battery cells accommodated in the battery pack, and a leak determiner configured to determine whether a battery cell leaks based on a detected result of the cell failure detector and based on the internal gas concentration corresponding to the estimated value of the insulation resistance.

The insulation resistance estimator may be configured to estimate the insulation resistance by using an insulation resistance function representing a correlation between temperature, pressure, and insulation resistance.

The leak determiner may be configured to determine that a leakage of the battery cell occurs when a cell failure is detected by the cell failure detector, and the internal gas concentration corresponding to the estimated value of the insulation resistance is greater than a leak threshold value.

The concentration estimator may be configured to estimate the internal gas concentration by using a relationship function representing a relationship between the insulation resistance of the battery pack and the internal gas concentration of the battery pack.

The battery management system may further include a state of health (SOH) estimator configured to estimate the SOH of the battery cell, wherein the concentration estimator is configured to estimate the internal gas concentration by using another relationship function corresponding to the SOH.

The battery management system may further include an insulation resistance measurer configured to obtain a measured value of the insulation resistance by measuring the insulation resistance of the battery pack, wherein the concentration estimator is configured to estimate the internal gas concentration of the battery pack corresponding to the measured value of the insulation resistance, and wherein the leak determiner is configured to determine whether the battery pack leaks based on a detected result of the cell failure detector, the estimated value of the insulation resistance, the measured value of the insulation resistance, the internal gas concentration corresponding to the estimated value of the insulation resistance, and the internal gas concentration corresponding to the measured value of the insulation resistance.

The leak determiner may be configured to determine that leakage of the battery pack occurs when all of the plurality of battery cells are in a normal state, and the internal gas concentration corresponding to the estimated value of the insulation resistance is greater than a leak threshold value.

The leak determiner may be configured to determine that leakage of the battery pack occurs when all of the plurality of battery cells are in a normal state, the internal gas concentration corresponding to the estimated value of the insulation resistance is equal to or less than a leak threshold value, the estimated value of the insulation resistance is greater than the measured value of the insulation resistance, and a difference between the internal gas concentration corresponding to the estimated value of the insulation resistance and the internal gas concentration corresponding to the measured value of the insulation resistance is greater than a threshold value.

The leak determiner may be configured to determine a state necessary to warn of a potential leakage of the battery pack when all of the plurality of battery cells are in a normal state, the internal gas concentration corresponding to the estimated value of the insulation resistance is equal to or less than a leak threshold value, the estimated value of the insulation resistance is greater than the measured value of the insulation resistance, and a difference between the internal gas concentration corresponding to the estimated value of the insulation resistance and the internal gas concentration corresponding to the measured value of the insulation resistance is equal to or less than a threshold value.

According to the embodiment of the present invention, because the sealing failure of a battery pack or a battery cell may be effectively detected, safety of a vehicle may be improved, and performance thereof may be effectively managed.

### BRIEF DESCRIPTION OF THE DRAWINGS

FIG. 1 illustrates a schematic view of a battery pack including a battery management system according to an embodiment.

FIG. 2 illustrates an example of an insulation resistance function used for estimating insulation resistance in a battery management system according to an embodiment.

FIG. 3 illustrates an example of a relationship function between concentration and insulation resistance used for estimating an internal gas concentration of a battery pack in a battery management system according to an embodiment.

FIG. 4 illustrates a table of leak detection conditions of a battery management system according to an embodiment.

FIG. 5 illustrates a flowchart of a method for detecting leakage of a battery in a battery management system according to an embodiment.

### DETAILED DESCRIPTION

Features of the inventive concept and methods of accomplishing the same may be understood more readily by reference to the following detailed description of embodiments and the accompanying drawings. Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element, layer, region, or component is referred to as being “on,” “connected to,” or “coupled to” another element, layer, region, or component, it can be directly on, connected to, or coupled to the other element, layer, region, or component, or one or more intervening elements, layers, regions, or components may be present. In addition, it will also be understood that when an element or layer is referred to as being “between” two elements or layers, it can be the only element or layer between the two elements or layers, or one or more intervening elements or layers may also be present.

Similarly, electrically connecting two elements includes not only directly connecting two elements but also connecting two elements with other element therebetween. The other element may include a switch, a resistor, a capacitor, etc. In describing embodiments, expression of being connected to something, if there is no expression of being directly connected thereto, means being electrically connected thereto.

In the following examples, the x-axis, the y-axis and the z-axis are not limited to three axes of a rectangular coordinate system, and may be interpreted in a broader sense. For example, the x-axis, the y-axis, and the z-axis may be perpendicular to one another, or may represent different directions that are not perpendicular to one another.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

When a certain embodiment may be implemented differently, a specific process order may be performed differently from the described order. For example, two consecutively described processes may be performed substantially at the same time or performed in an order opposite to the described order.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, a battery management system according to an embodiment, and a method for detecting leakage thereof, will be described with reference to the accompanying necessary drawings.

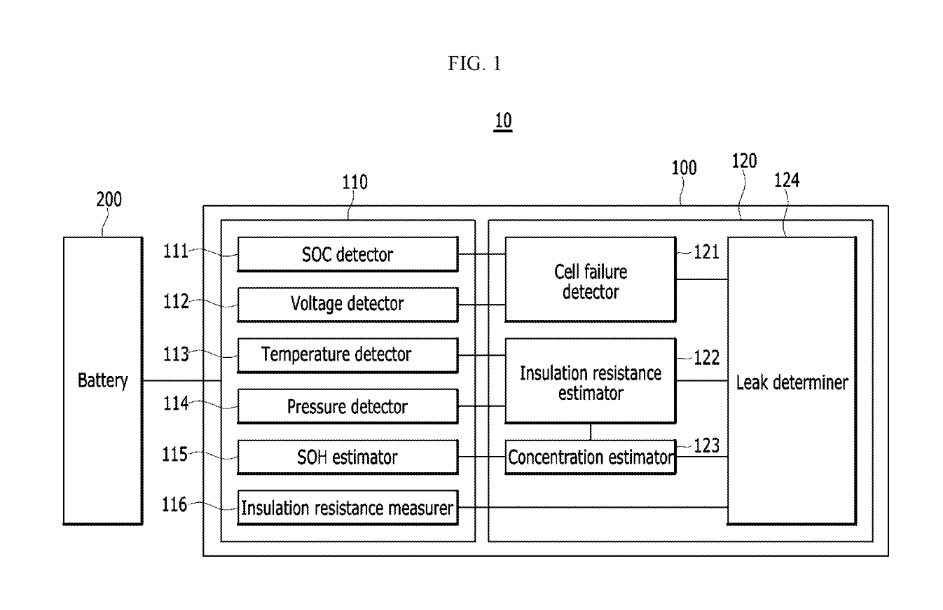

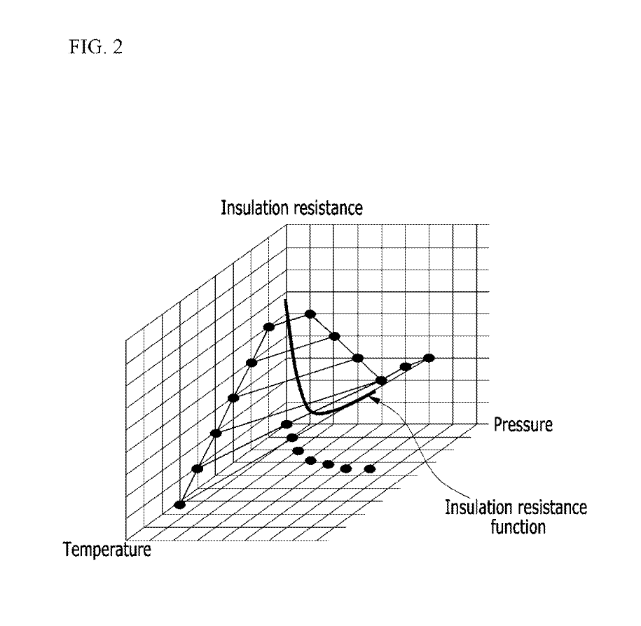

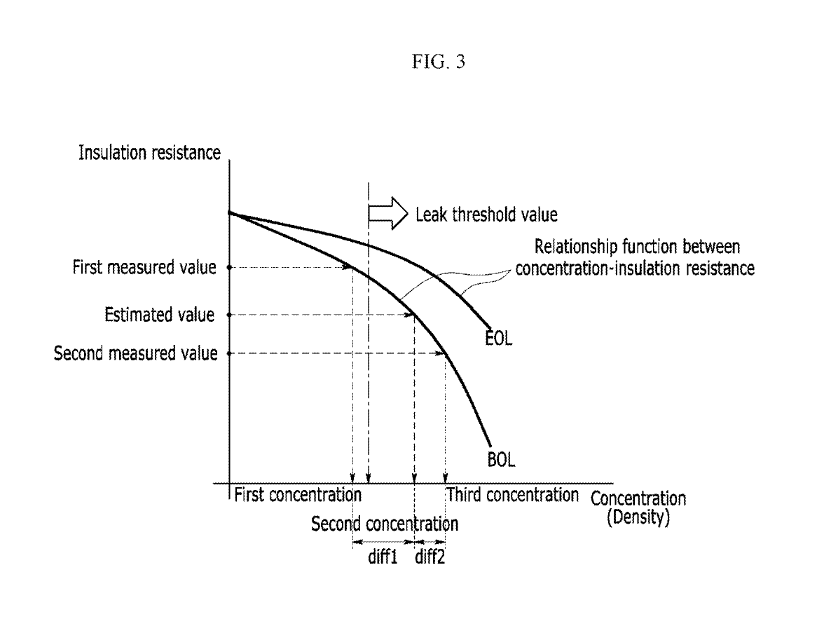

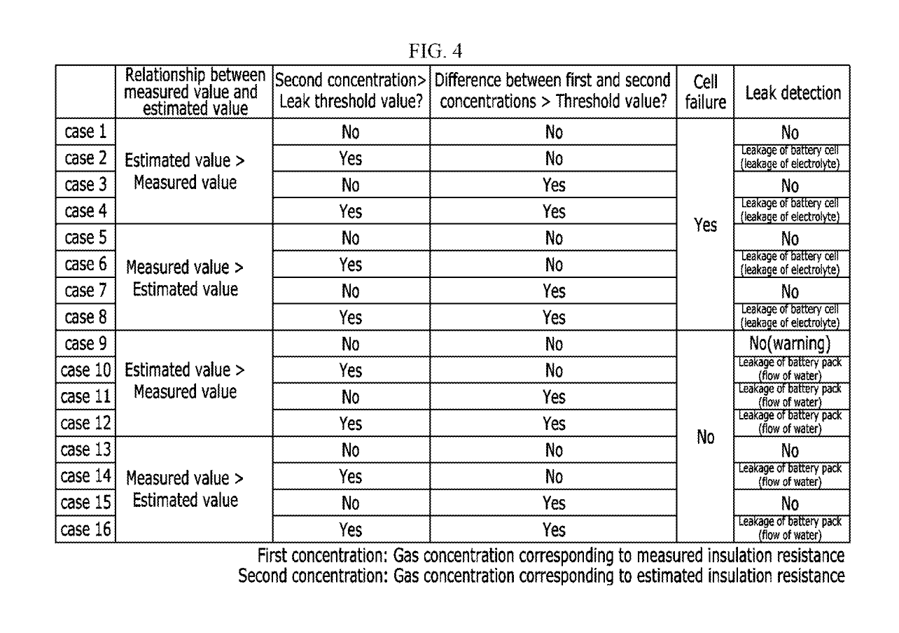

FIG. 1 illustrates a schematic view of a battery pack including a battery management system according to an embodiment, FIG. 2 illustrates an example of an insulation resistance function used for estimating insulation resistance in a battery management system according to an embodiment, FIG. 3 illustrates an example of a relationship function between concentration and insulation resistance used for estimating an internal gas concentration of a battery pack in a battery management system according to an embodiment, and FIG. 4 illustrates a table of leak detection conditions of a battery management system according to an embodiment.

Referring to FIG. 1, a battery pack 10 according to an embodiment may include a battery 200 and a battery management system (BMS) 100. The battery 200 may be a high voltage battery in which a plurality of cells are connected in parallel or in series. The battery management system 100 may include a battery state detector 110 and a leak detector 120. In FIG. 1, the battery 200 is connected to the battery state detector 110.

The battery state detector 110 serves to detect a state of the battery 200 and an internal state of the battery pack including the battery 200. The battery state detector 110 may include a state of charge (SOC) detector 111, a voltage detector 112, a temperature detector 113, a pressure detector 114, a state of health (SOH) estimator 115, and an insulation resistance measurer 116.

The SOC detector 111 detects the SOC based on a voltage and a charging current or a discharging current of each cell included in the battery 200.

The voltage detector 112 detects the voltage of each cell included in the battery 200 through a voltage sensor.

The temperature detector 113 detects an internal temperature of the battery pack 10. The temperature detector 113 may measure a temperature of each of the cells included in the battery 200 through a temperature sensor, and the temperature detector 113 may estimate the internal temperature of the battery pack 10 based on the measured temperature of each cell and based on an internal temperature gradient of the battery pack 10. The temperature detector 113 may detect the internal temperature of the battery pack 10 through a separate temperature sensor installed in the battery pack 10.

The pressure detector 114 detects internal pressure of the battery pack 10. The pressure detector 114 may detect the internal pressure of the battery pack 10 through a pressure sensor and the like.

The SOH estimator 115 estimates SOH of the battery cells. The SOH is a parameter of expressing a degradation degree (e.g., a degreed of degradation) of the battery cell as a percentage. The SOH may be affected by usage temperature of the battery cell, an SOC usage range, amounts of charging and discharging currents, frequencies of charging and discharging, etc.

For example, the SOH estimator 115 may estimate the SOH of the battery cell based on a decrease of capacity, or an increase of resistance, of each battery cell due to deterioration thereof as compared to initial capacity, or an initial output, thereof.

Alternatively, the SOH estimator 115 may monitor the temperature and the charging and discharging currents of the battery cell to calculate a degradation degree of each cell, and then the SOH estimator 115 may estimate the SOH of the battery cell based on the calculated degradation degree.

Further, the SOH estimator 115 may estimate a current capacity and a current internal resistance of each battery cell, and then the SOH estimator 115 may estimate the SOH of each battery cell based on the estimated current capacity and internal resistance. In this case, the current capacity of each battery cell may be estimated by monitoring the voltage and the current of the battery cell. Alternatively, the current capacity of the battery cell may be estimated based on an open circuit voltage (OCV) and the SOC of each battery cell.

The aforementioned methods of estimating the SOH of the battery cell, as an example, are performed by the SOH estimator 115, and the SOH estimator 115 may estimate the SOH with various methods other than the aforementioned methods.

The insulation resistance measurer 116 measures insulation resistance between a negative terminal, or a positive terminal, of the battery pack 10, and a vehicle body in which the battery pack 10 is installed. The insulation resistance measurer 116 may measure the insulation resistance through a separate sensor for measuring the insulation resistance of the battery pack 10.

The leak detector 120 may include a cell failure detector 121, an insulation resistance estimator 122, a concentration estimator 123, and a leak determiner 124.

The cell failure detector 121 detects whether or not each battery cell fails based on the SOC and the voltage thereof. The SOC and the voltage of each cell may be respectively inputted from the SOC detector 111 and the voltage detector 112.

The insulation resistance estimator 122 may estimate the insulation resistance of the battery pack 10 based on the internal temperature and pressure of the battery pack 10. The internal temperature and pressure of the battery pack 10 may be respectively inputted from the temperature detector 113 and the pressure detector 114.

The insulation resistance estimator 122 may estimate the insulation resistance of the battery pack 10 by using an insulation resistance function based on the ideal gas state equation (PV=nRT (P: pressure, V: volume, n: number of moles of gas, R: gas constant, T: absolute temperature)).

FIG. 2 illustrates an example of an insulation resistance function used by the insulation resistance estimator 122 for estimating the insulation resistance. According to the ideal gas state equation, when temperature and pressure of gas in a predetermined space are known, concentration of the gas may be estimated. The internal gas concentration of the battery pack 10 is a parameter that is correlated with the insulation resistance. Accordingly, when the internal gas concentration of the battery pack 10 is known, the internal insulation resistance of the battery pack 10 may be estimated. The correlation between the internal gas concentration and the insulation resistance of the battery pack 10 may be obtained through an experiment for the battery pack 10.

Accordingly, in the present embodiment, based on the correlation between the internal temperature and pressure of the battery pack 10, based on the internal gas concentration thereof, and based on the correlation between the internal gas concentration of the battery pack 10 and the insulation resistance thereof, as shown in FIG. 2, the insulation resistance function may be derived, and the insulation resistance of the battery pack 10 may be estimated based on the derived insulation resistance function. Referring to FIG. 2, when the internal temperature and pressure of the battery pack 10 are inputted, the insulation resistance function may output the insulation resistance of the battery pack 10 corresponding to the internal temperature and pressure.

As shown in FIG. 2, the insulation resistance estimator 122 may calculate the value of the insulation resistance by using the insulation resistance function for calculating the insulation resistance value according to the temperature and the pressure.

Based on an insulation resistance map generated by mapping each temperature and pressure to correspond to the insulation resistance based on the insulation resistance function of FIG. 2, the insulation resistance estimator 122 may obtain the insulation resistance corresponding to the internal temperature and pressure of the battery pack 10.

The concentration estimator 123 may estimate different internal gas concentrations of the battery pack 10 respectively corresponding to the insulation resistance estimated by the insulation resistance estimator 122 and the insulation resistance estimated by the insulation resistance measurer 116.

The correlation between the internal gas concentration and insulation resistance of the battery pack 10 may be represented as a relationship function, such as that of the graph shown in FIG. 3. Referring to FIG. 3, as the internal gas concentration of the battery pack 10 increases, the resistance value of the insulation resistance decreases.

The correlation between the internal gas concentration and insulation resistance of the battery pack 10 varies depending on the degradation degree of the battery 200. Referring to FIG. 3, it can be seen that the correlation between the internal gas concentration and insulation resistance of the battery pack 10 generated at an end of life (EOL) of the battery 200 is different from the correlation between the internal gas concentration and insulation resistance of the battery pack 10 generated at a beginning of life (BOL) of the battery 200. In the same gas concentration condition, the insulation resistance is smaller in a BOL range than in an EOL range.

As shown in FIG. 3, because the correlation between the internal gas concentration and insulation resistance of the battery pack 10 varies according to the degradation degree of the battery 200, the concentration estimator 123 may estimate the gas concentration by using the relationship function that is varied according to the SOH of the battery 200. In this case, the SOH of the battery 200 may be obtained from the SOH of each cell estimated by the SOH estimator 115.

Referring to FIG. 3 as an example, when a current SOH of the battery 200 corresponds to the BOL of the battery 200, the concentration estimator 123 may estimate a first concentration/first gas concentration corresponding to a first measured value of the insulation resistance measured by the insulation resistance measurer 116 and a second concentration/second gas concentration corresponding to a first estimated value of the insulation resistance estimated by the insulation resistance estimator 122, by using the relationship function corresponding to the BOL of the battery 200.

The correlation between the internal gas concentration and insulation resistance of the battery pack 10 may be obtained through an experiment for a different battery pack that has the same characteristics as the battery pack 10. The relationship function between the internal gas concentration and insulation resistance of the battery pack 10 may be derived by monitoring changes of the gas concentration and the insulation resistance in each SOH while changing the SOHs of the batteries with the same characteristics.

In the present embodiment, for the estimation of gas concentration by the concentration estimator 123, a range from the BOL to the EOL of the battery 200 may be divided by a plurality of SOH ranges, and each gas concentration map corresponding to each SOH range may be previously set. The gas concentration map may be formed by matching each insulation and gas concentration so that each insulation resistance corresponds to gas concentration based on a relationship function corresponding to each SOH range.

When using the gas concentration map, the concentration estimator 123 may select one of a plurality of gas concentration maps (e.g., predetermined gas concentration maps) based on the current SOH of the battery 200. The concentration estimator may also obtain a gas concentration respectively corresponding to an actually measured insulation resistance and an actually estimated insulation resistance based on the selected gas concentration map.

Hereinafter, for better understanding and ease of description, the gas concentration estimated to correspond to the insulation resistance measured by the insulation resistance measurer 116 designates a “first concentration”, and the gas concentration estimated to correspond to the insulation resistance estimated by the insulation resistance estimator 122 designates a “second concentration”.

The leak determiner 124 detects whether the battery cell or the battery pack 10 leaks based on the insulation resistance detected by the insulation resistance measurer 116, the insulation resistance estimated by the insulation resistance estimator 122, the failure result detected by the cell failure detector 121, and the first and second concentrations detected by the concentration estimator 123.

FIG. 4 illustrates a leak detection condition table of a leak determiner.

Referring to FIG. 4, when a cell failure of at least one battery cell is detected by the cell failure detector 121, and when the second concentration corresponding to the insulation resistance is greater than a leak threshold value (e.g., cases 2, 4, 6, and 8 in FIG. 4), the leak determiner 124 determines a sealing failure of the battery cell. Because the estimated value of the insulation resistance is estimated based on the internal temperature and pressure of the battery pack 10, the gas concentration estimated by the estimated value of the insulation resistance may be considered as corresponding to an internal gas state of the battery pack 10. Accordingly, in the state in which the cell failure of at least one battery cell is detected, the second concentration corresponding to the estimated value of the insulation resistance being greater than the leak threshold value may mean that the electrolyte of the battery cell leaks, and thus the internal gas concentration of the battery pack 10 increases. When the leakage of the battery cell is determined, the leak determiner 124 transmits an error flag corresponding to the leakage of the battery cell to an external controller.

Although the cell failure of at least one battery cell is detected by the cell failure detector 121, when the second concentration corresponding to the estimated value of the insulation resistance is equal to or less than the leak threshold value (e.g., cases 1, 3, 5, and 7 in FIG. 4), the leak determiner 124 determines that the battery cell or the battery pack 10 does not leak. In this case, the battery management system 100 determines that the cell failure occurs due to factors other than the leakage of the battery cell or the battery pack 10, and then the battery management system 100 may further perform a process for determining the other factors causing the cell failure of the battery cell.

In a state in which all of the battery cells are normal (e.g., all of the battery cells are in a normal state), when the second concentration corresponding to the estimated value of the insulation resistance is greater than the leak threshold value (e.g., cases 10, 12, 14, and 16 in FIG. 4), the leak determiner 124 determines the battery pack 10 as leaking. When the sealing failure of the battery pack 10 occurs, the internal gas of the battery pack 10 enters an excessive humidity state due to a flow of water, thus the second concentration corresponding to the internal gas state of the battery pack 10 may exceed the leak threshold value. Accordingly, in the state in which all of the battery cells are normal, the second concentration corresponding to the estimated value of the insulation resistance being greater than the leak threshold value may mean that the internal gas of the battery pack 10 enters the excessive humidity state due to the sealing failure of the battery pack 10. When the battery pack leaks, the leak determiner 124 transmits an error flag corresponding to the leakage of the battery pack to an external controller.

In a state in which all of the battery cells are normal and the second concentration corresponding to the estimated value of the insulation resistance is less than or equal to the leak threshold value, when the measured value of the insulation resistance is greater than the estimated value of the insulation resistance (e.g., cases 13 and 15 in FIG. 4), the leak determiner 124 determines that the battery cell or the battery pack 10 does not leak.

In a state in which all of the battery cells are normal and the second concentration corresponding to the estimated value of the insulation resistance is less than or equal to the leak threshold value, when the estimated value of the insulation resistance is greater than the measured value of the insulation resistance (e.g., cases 9 and 11 in FIG. 4) and a difference between the first and second concentrations (refer to diff1 and diff2 of FIG. 3) is greater than a threshold value (e.g., case 11 in FIG. 4), the leak determiner 124 determines that the battery pack 10 leaks. Further, the leak determiner 124 transmits an error flag corresponding to the leakage of the battery pack to an external controller.

In a state in which all of the battery cells are normal and the second concentration corresponding to the estimated value of the insulation resistance is less than or equal to the leak threshold value, when the estimated value of the insulation resistance is greater than the measured value of the insulation resistance, and the difference between the first and second concentrations (refer to diff1 and diff2 of FIG. 3) is less than or equal to the threshold value (e.g., case 9 in FIG. 4), the leak determiner 124 determines it as a state necessary to warn of the leakage of the battery pack 10 (e.g., no leakage detected, but a warning is sent to warn of a potential leakage). That is, the leak determiner 124 determines that another determining process may be used for determining whether the battery pack 10 leaks. In this case, the battery management system 100 may further perform an insulation determining process that uses the measured value of the insulation resistance, thus it may finally determine whether the sealing of the battery pack 10 fails.

The functions of the constituent elements (the SOC detector 111, the voltage detector 112, the temperature detector 113, the pressure detector 114, the SOH estimator 115, the insulation resistance measurer 116, the cell failure detector 121, the insulation resistance estimator 122, the concentration estimator 123, and the leak determiner 124) included in the battery management system 100 having the aforementioned structure may be performed by a processor that is implemented by at least one central processing unit (CPU) or a chipset, a microprocessor, etc.

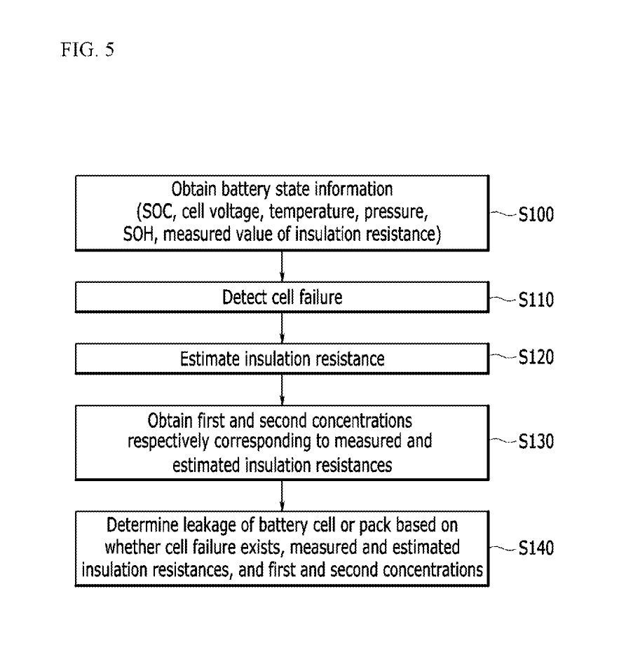

FIG. 5 illustrates a flowchart of a method for detecting leakage of a battery in a battery management system according to an embodiment.

Referring to FIG. 5, the battery management system 100 obtains the battery state information such as the SOC and the cell voltage of each battery cell included in the battery 200, the internal temperature and pressure of the battery pack 10, the SOH, and the measured value of the insulation resistance of the battery 200, etc. (S100).

The battery management system 100 detects whether the failure of each battery cell occurs by using the SOC and the cell voltage of the battery cell obtained at S100 (S110).

In addition, the battery management system 100 estimates the insulation resistance of the battery pack 10 by using the internal temperature and pressure of the battery pack 10 obtained at S100 (S120).

At S120, the battery management system 100 estimates the value of the insulation resistance by using the insulation resistance function for calculating the value of the insulation resistance according to the temperature and the pressure.

When the estimated value of the insulation resistance is obtained, the battery management system 100 obtains the gas concentrations (the first and second concentrations) respectively corresponding to the measured value of the insulation resistance and the estimated value of the insulation resistance (S130).

At S130, the battery management system 100 may estimate the gas concentrations (the first and second concentrations) respectively corresponding to the measured value of the insulation resistance and the estimated value of the insulation resistance by using a relationship function of concentration-insulation resistance. The relationship function of concentration-insulation resistance is derived through an experiment, and may be changed according to the SOH of the battery 200. That is, the battery management system 100 may estimate the gas concentrations (the first and second concentrations) respectively corresponding to the measured value of the insulation resistance and the estimated value of the insulation resistance by using the relationship function of concentration-insulation resistance that is changed according to the SOH of the battery 200.

When the gas concentrations (the first concentration and second concentrations) respectively corresponding to the measured value of the insulation resistance and the estimated value of the insulation resistance are estimated at S130, the battery management system 100 determines whether the battery cell or the battery pack 10 leaks based on whether or not the cell failure exists, and also based on the measured value of the insulation resistance, the estimated value of the insulation resistance, and the first and second concentrations (S140).

At S140, the battery management system 100 may determine whether the battery cell or the battery pack 10 leaks based on the table illustrated in FIG. 4.

When it is determined that the battery cell or the battery pack leaks at S140, the battery management system 100 may transmit the failure information corresponding to the leakage of the battery cell or the battery pack to an external controller.

According to the embodiment, the battery management system may improve the detecting performance of the sealing failure of the battery pack and the battery cell. Accordingly, by early detection of the sealing failure of the battery pack or the battery cell, and by warning performance deterioration or high voltage danger of a vehicle, it is possible to improve and manage safety and performance of the vehicle as well as of the battery pack and to implement a high Automotive Safety Integrity Level (ASIL).

The drawings and the detailed description of the invention given so far are only illustrative, and they are only used to describe embodiments the present invention, but are not used to limit the meaning or restrict the range of the present invention with embodiments described in the claims. Therefore, it will be appreciated to those skilled in the art that various modifications may be made and other equivalent embodiments are available. Accordingly, the actual scope of embodiments of the present invention must be determined by the spirit of the appended claims and their functional equivalents.

### DESCRIPTION OF SOME OF THE REFERENCE CHARACTERS

10: battery pack
100: battery management system
110: battery state detector
111: SOC detector
112: voltage detector
113: temperature detector
114: pressure detector
115: SOH estimator
116: insulation resistance measurer
120: leak detector
121: cell failure detector
122: insulation resistance estimator
123: concentration estimator
124: leak determiner
200: battery

What is claimed is:

1. A battery management system comprising:
an insulation resistance estimator configured to estimate insulation resistance corresponding to internal temperature and pressure of a battery pack to obtain an estimated value of the insulation resistance;
a concentration estimator configured to estimate an internal gas concentration of the battery pack corresponding to the estimated value of the insulation resistance;
a cell failure detector configured to detect whether a plurality of battery cells fail based on a state of charge (SOC) and a voltage of the plurality of battery cells accommodated in the battery pack; and
a leak determiner configured to determine whether a battery cell leaks based on a detected result of the cell failure detector and based on the internal gas concentration corresponding to the estimated value of the insulation resistance.

2. The battery management system of claim 1, wherein the insulation resistance estimator is configured to estimate the insulation resistance by using an insulation resistance function representing a correlation between temperature, pressure, and insulation resistance.

3. The battery management system of claim 1, wherein the leak determiner is configured to determine that a leakage of the battery cell occurs when:
a cell failure is detected by the cell failure detector; and
the internal gas concentration corresponding to the estimated value of the insulation resistance is greater than a leak threshold value.

4. The battery management system of claim 1, wherein the concentration estimator is configured to estimate the internal gas concentration by using a relationship function representing a relationship between the insulation resistance of the battery pack and the internal gas concentration of the battery pack.

5. The battery management system of claim 4, further comprising a state of health (SOH) estimator configured to estimate the SOH of the battery cell,
wherein the concentration estimator is configured to estimate the internal gas concentration by using another relationship function corresponding to the SOH.

6. The battery management system of claim 1, further comprising an insulation resistance measurer configured to obtain a measured value of the insulation resistance by measuring the insulation resistance of the battery pack,
wherein the concentration estimator is configured to estimate the internal gas concentration of the battery pack corresponding to the measured value of the insulation resistance, and
wherein the leak determiner is configured to determine whether the battery pack leaks based on a detected result of the cell failure detector, the estimated value of the insulation resistance, the measured value of the insulation resistance, the internal gas concentration corresponding to the estimated value of the insulation resistance, and the internal gas concentration corresponding to the measured value of the insulation resistance.

7. The battery management system of claim 6, wherein the leak determiner is configured to determine that leakage of the battery pack occurs when:
all of the plurality of battery cells are in a normal state; and
the internal gas concentration corresponding to the estimated value of the insulation resistance is greater than a leak threshold value.

8. The battery management system of claim 6, wherein the leak determiner is configured to determine that leakage of the battery pack occurs when:
all of the plurality of battery cells are in a normal state;
the internal gas concentration corresponding to the estimated value of the insulation resistance is equal to or less than a leak threshold value;
the estimated value of the insulation resistance is greater than the measured value of the insulation resistance; and
a difference between the internal gas concentration corresponding to the estimated value of the insulation resistance and the internal gas concentration corresponding to the measured value of the insulation resistance is greater than a threshold value.

9. The battery management system of claim 6, wherein the leak determiner is configured to determine a state necessary to warn of a potential leakage of the battery pack when:
all of the plurality of battery cells are in a normal state;
the internal gas concentration corresponding to the estimated value of the insulation resistance is equal to or less than a leak threshold value;
the estimated value of the insulation resistance is greater than the measured value of the insulation resistance; and
a difference between the internal gas concentration corresponding to the estimated value of the insulation resistance and the internal gas concentration corresponding to the measured value of the insulation resistance is equal to or less than a threshold value.
